(19) United States
(12) Patent Application Publication
(10) Pub. No.: US 2008/0069107 A1
(43) Pub. Date: Mar. 20, 2008

(54) Scalable packet based network

(75) Inventors: Rute Esteves Carvalho Sofia, Munchen (DE); Roch Guerin, Newton Square, PA (US); Saikat Ray, Bridgeport, CT (US)

Correspondence Address: Siemens Corporation;Intellectual Property Department, 170 Wood Avenue South, Iselin, NJ, 08830, US

(73) Assignee: Siemens Aktiengesellschaft

(21) Appl. No.: 11/786,794

(22) Filed: Apr. 12, 2007

Related U.S. Application Data
(60) Provisional application No. 60/845,231, filed on Sep. 15, 2006.

(51) Int. Cl. H04L 12/56

(52) U.S. Cl. 370/392

(57) ABSTRACT

A network node for a scalable packet based network comprising ports for reception and transmission of data packets of network segments connected to the respective ports of the network node, a forwarding table which stores for each port of the network node addresses of nodes reachable through the respective port of the network node, a registering table which stores a list of node addresses registered with the network node wherein the network node forms a registrar node for these addresses, and a registrar table which stores information data on all network nodes which are registrar nodes of the network.

### CROSS REFERENCE TO RELATED APPLICATIONS

The present application claims the benefit of the provisional patent application filed on Sep. 15, 2006, and assigned application No. 60/845,231.

### BACKGROUND OF THE INVENTION

The invention relates to a scalable packet based network wherein storing addresses and looking-up of addresses is distributed between network nodes of said packet based network.

An example of a packet based network is an Ethernet network.

The Ethernet network is a packet-switched network comprised of nodes and segments. Nodes are represented by unique and immutable identifiers—MAC addresses. Furthermore, the Ethernet nodes comprise a small subset of nodes (bridges), here named network nodes. An Ethernet segment is a small share of the Ethernet network where nodes that are not network nodes are attached to. Furthermore, Ethernet network nodes allow transmission between different Ethernet segments.

Ethernet network nodes automatically discover where to forward data packets without the need for any configuration. The addressing scheme of Ethernet is flat, i.e., the MAC addresses have no association with a node's location within the network. Consequently, in order to be able to successfully forward every single data packet, an Ethernet node has to keep forwarding entries for all nodes present in the Ethernet network, e.g. one entry for each individual MAC address that uniquely represents a node.

A basic and simple Ethernet operation relies on two fundamental mechanisms, i.e., learning of every single MAC address within a network and on demand creation of forwarding state by performing a so-called flooding mechanism. When a bridge of the Ethernet network does not have the association of the destination MAC address to a port of the bridge—does not know where to forward the packet—, the bridge broadcasts the received data packet on all of its ports except the one port where the bridge has received the data packet.

FIGS. 1A-1D illustrates how a bridge within an Ethernet operates. Bridges update their forwarding table entries dynamically by examining the source MAC addresses SA of every data packet that crosses the bridge. The bridge B then populates its forwarding table with the association between the source MAC address SA and the port p where the packet was received.

FIG. 1A shows an example network for illustrating a forwarding table population according to the state of the art.

After bridge B as shown in FIG. 1A is powered up and an internally specified warm-up time has gone by, bridge B passively listens to data packets DP being received on its ports, filtering the source address fields SA of all data packets DP. In the given example, node W1 located on the Ethernet segment S1 sends a data packet destined to node W3 which is located on the Ethernet segment S2. Bridge B filters the address of node W1 (source address of the packet DP_and adds an entry to its forwarding table, which contains the association of W1 to the port that connects segment S1, as illustrated in FIG. 1B. Furthermore, realizing that there is no association of the destination address W3 to a specific port in its forwarding table, Bridge B forwards the data packet DP to all segments (S2, S3) with the exception of S1 (given that S1 is connected to the port where DP was received).

When the node W3 responds to the request of node W1 (with a DP1 packet), the bridge B adds the source address of DP1 (corresponding to the MAC address of node W3) to its forwarding table, associating it to port p2, as illustrated in FIG. 1C. Bridge B then forwards the data packet DP only to segment S1 because it has already learned that station W1 is associated to port p1. Consequently, the bridge B does not forward the data packet DP from node W3 to all the network segments connected to its ports but only to the network segment S1.

When a bridge B cannot find an entry to the MAC destination address DA of a packet DP it receives in its forwarding table, a cache-miss is said to occur. The bridge B then sends a copy of DP (broadcasts) on each of its ports except the one where the packet was received from, i.e. it initiates a flooding procedure.

### SUMMARY OF THE INVENTION

A disadvantage of the flooding procedure is that the broadcasting of the data packet DP consumes a lot of network resources and thus negatively impacts the scalability of the network. This disadvantage becomes even more severe when the network becomes more complex, for instance, due to an increasing number of nodes within the network. Large scale Ethernet networks (of which Metropolitan Area Networks are an example) comprise a large number of nodes (and consequently a large number of MAC addresses). Consequently, a large number of cache-misses may occur, which negatively affects the performance of the network. In particular, a conventional Ethernet network having many nodes may experience a large, steady state fraction of broadcast data traffic which consumes a significant amount of network resources and as a result affects the global scalability of the network.

Accordingly, it is an object of the present invention to provide a network which can be scaled by minimizing the waste of network resources that is a consequence of having to perform broadcasts for address resolution.

This object is achieved by an address registration and an address resolution method according to the present invention as well as by a network node for scalable packet-based network according to the present invention.

The invention provides a scheme that avoids the use of broadcasts in case of a cache-miss by providing a distributed address registration, and address resolution mechanism.

Within the context of the invention, a network node incorporates in a preferred embodiment, besides the said forwarding table, three additional logical tables, i.e., an owning table, a registering table, and a registrar table. The owning table contains identifiers (addresses) of said local nodes. A local node is a node which is either directly connected to the owning network node or to a legacy segment connected to a port of the owning network node. The network node is the owner network node of such local addresses. The registering table holds a list of node identifiers registered with the network node which is then deemed the registrar node for such nodes. The registrar table comprises the identifiers of all the nodes that play the role of registrar node.

The invention provides a method for registering a node address in a registering table of a registrar node, comprising the following:

an owning network node (O) filters (learns) a source address (SA) of a data packet sent by a local node located in a network segment connected to a port (p) of the owning network node;

node (O) adds an entry in its forwarding table corresponding to the association between the learned node address (SA) and the port (p) where the packet was received;

node (O) stores the learned node address (SA) in its owning table in relation to said port p;

node (O) computes a predetermined function (F(SA)), which depends on the learned node address (SA) for each node address stored in the registrar table of node (O) to supply the owning network node (O) with a registrar node address according to a predetermined criterion;

wherein the owning network node (O) registers the learned node address (SA) in a registering table of the registrar node indicated by said registrar node address.

In one embodiment of the method according to the present invention, the function (F) is computed by calculating an absolute difference between the learned node address and the node addresses stored in the registrar table of said owning network node.

In one embodiment of the method according to the present invention, the registrar node address is selected whose calculated function value has a minimal absolute value of calculated function values.

In one embodiment of the method according to the present invention, node addresses are formed by MAC addresses.

In one embodiment of the method according to the present invention, the network nodes are formed by Ethernet bridges.

In one embodiment of the method according to the present invention, the method is performed each time a network node learns an address of a node within a segment connected to said port of said network node during operation of the network.

In one embodiment of the method according to the present invention, the method is performed periodically after a bootstrapping procedure when starting the network operation.

The invention further provides an address resolution method for a destination address (DA) of a data packet (DP) by a network node (N) of a network comprising the following:

node (N) receiving the data packet (DP) having the destination address (DA) at a port of the network node;

node (N) performing a look-up for the destination address (DA) in the forwarding table of said network node, wherein

if the destination address (DA) is not present in the forwarding table of node (N) then having node (N) performing a lookup for destination address (DA) in its owning table.

if the destination address (DA) is not present in said forwarding table nor in the owning table of node (N), the network node (N) computes a predetermined function (F(DA)), which depends on the learned node address (DA) for each node address stored in the registrar table of the node (N), to supply this node (N) with a registrar node address according to a predetermined criterion; and

network node (N) forwards the data packet (DP) to the registrar node identified by the registrar node address obtained.

In one embodiment of the method according to the present invention, a control packet containing the address of the owning node of the destination address (DA) is sent by the selected registrar node to node (N).

In one embodiment of the method according to the present invention, the registrar node address is selected whose calculated function F(.) value has a minimal absolute value of calculated function values.

The invention further provides a network node for a scalable packet-based network further comprising, besides a forwarding table:

an owning table which stores, for each port of said network node, learned local node addresses;

a registering table which holds a list of addresses registered with the network node, wherein the network node is a registrar node for these addresses;

a registrar table comprising information on all nodes which are registrar nodes of said network.

In a preferred embodiment, the network node according to the present invention comprises computing means for learning node addresses of nodes connected to a port and for storing the learned node addresses in said owning table.

In one embodiment of the network node according to the present invention, comprises computing means for calculating a predetermined function value dependent upon a learned node address and the node addresses stored in the registrar table of said network node.

In one embodiment of the network node according to the present invention, the computing means selects from the calculated function value a node address whose function value fulfils a predetermined selection criterion.

In one embodiment of the network node according to the present invention, the function is formed by a subtracting function which calculates the absolute difference between a learned node address and a node address stored in said registrar table of said network node.

In one embodiment of the network node according to the present invention, the selection criterion is to select a minimal function value of all calculated function values.

In a preferred embodiment of the network node according to the present invention, each learned node address in the owning table is registered by said network node in the registering table of a registrar node.

In a preferred embodiment of the network node according to the present invention, the network node is a bridge.

In one embodiment of the network node according to the present invention, the node addresses and network node addresses are formed by MAC addresses.

In an alternative embodiment of the network node according to the present invention, the criterion followed by the predetermined function F(A) computes intermediate function values for each network node address stored in the registrar table of the network node and then selects the network node address that corresponds to the maximum intermediate function value. For the case where the maximum intermediate function value is obtained for different network node addresses, ties are broken using a deterministic process such as choosing the network node with a network node address that is numerically the lowest among the maximizers.

The invention further provides a scalable packet-based network comprising a plurality of nodes, wherein storing of node addresses and looking up of node addresses is distributed between network nodes of said packet-based network.

In one embodiment of the network node according to the present invention, the packet-based network is an Ethernet network.

### BRIEF DESCRIPTION OF THE FIGURES

In the following embodiments of the address registration and address resolution methods as well as embodiments of the network node and the scalable packet based network according to the present invention are described by way of non-limiting examples with reference to the enclosed figures.

FIGS. 1A-1C illustrate the operation of an Ethernet bridge according to state-of-the-art:

FIG. 2 shows a flowchart of an embodiment of an address registering method according to the present invention;

FIG. 3 shows a flowchart of an embodiment of an address resolution method according to the present invention;

FIG. 4 shows an embodiment of a network node according to the present invention;

FIG. 5 shows an exemplary network illustrating the functionality of the method according to the present invention;

FIGS. 6A-6C show tables corresponding to the exemplary network as shown in FIG. 5;

FIG. 7 shows a further exemplary network for illustrating the functionality of the method according to the present invention;

FIG. 8 shows a table corresponding to the exemplary network as shown in FIG. 7.

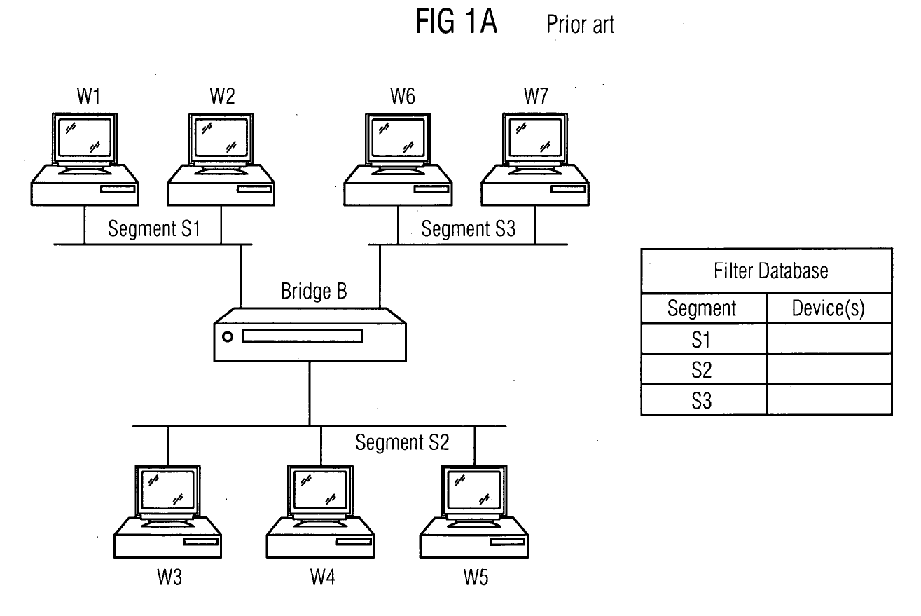

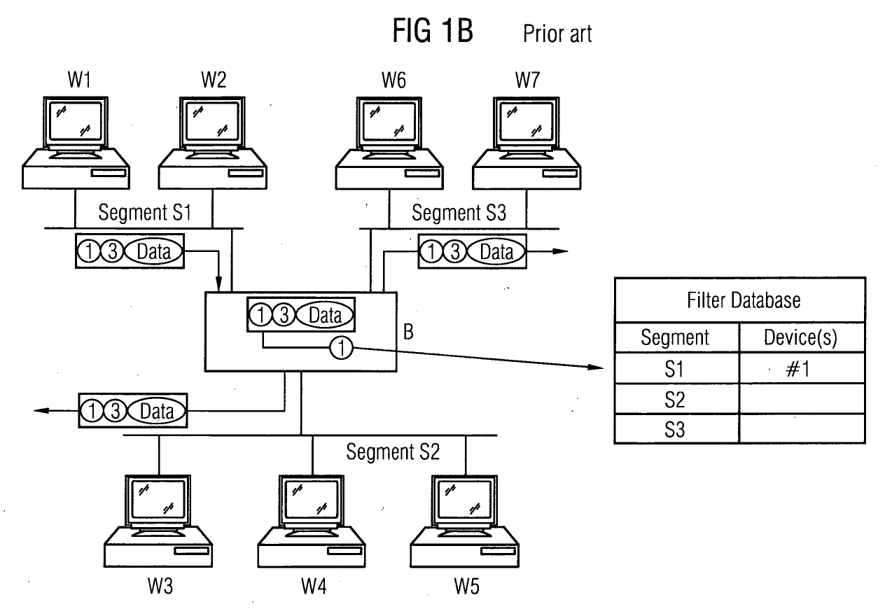

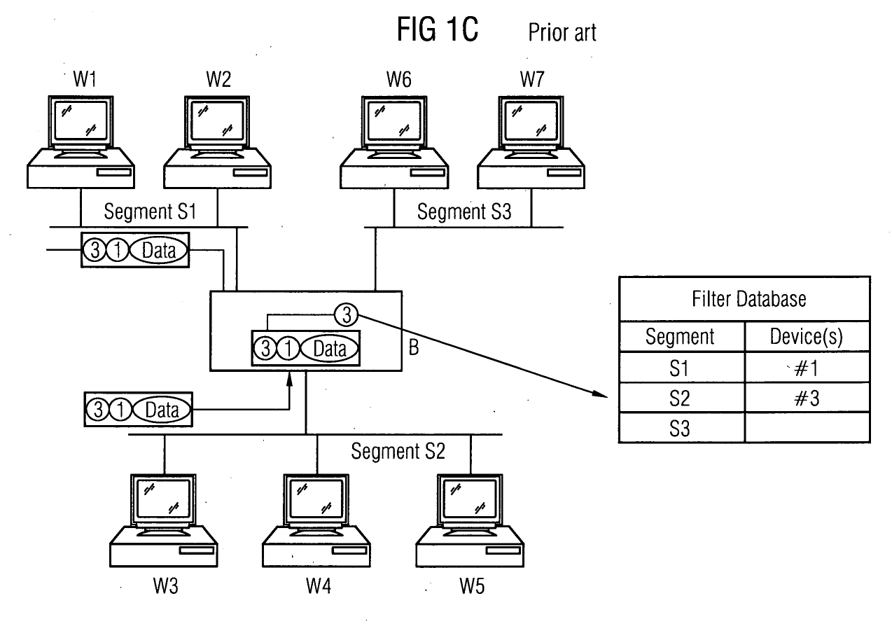

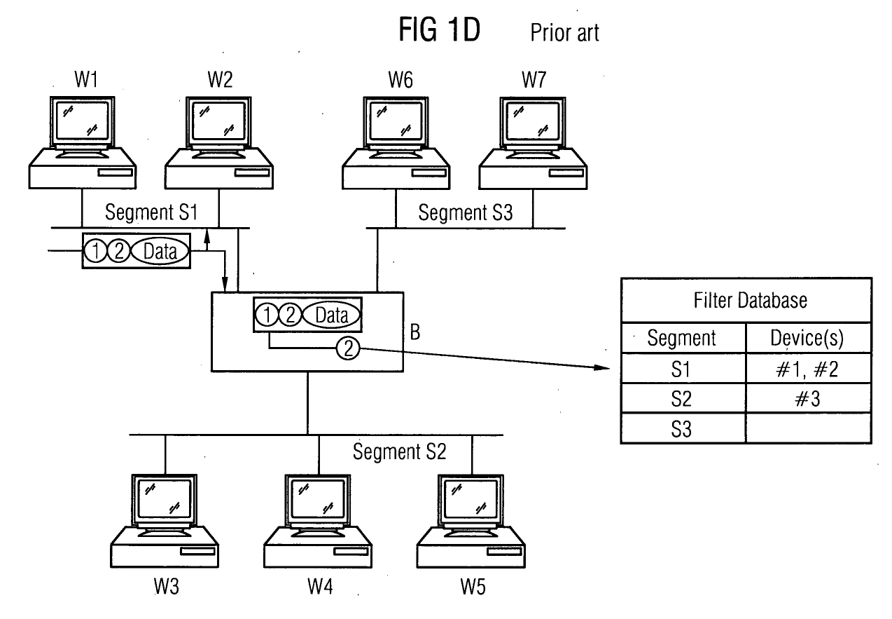

### DETAILED DESCRIPTION OF THE FIGURES

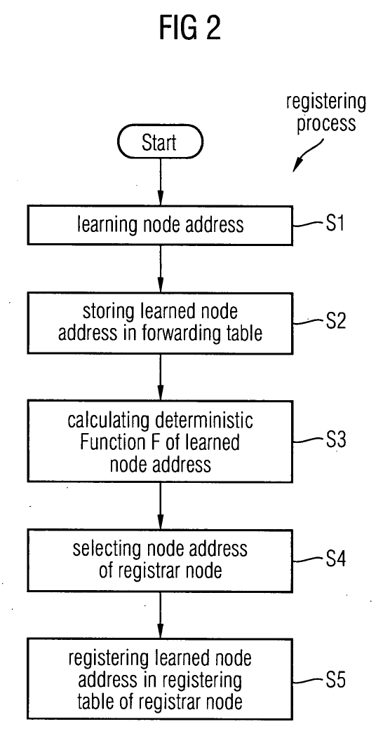

As can be seen from FIG. 2, in one embodiment, the method for registering a node address. The registering process comprises a method for registering a node address learned by a network node in a registering table of another network node of the same network.

In S1, a source address SA of a data packet DP received at a port p of a network node 1 is learned as the address of a node within a network segment connected to the port p.

In S2, the learned association of node address SA to the port p information is stored in a forwarding table 4A.

In S3, if the network node 1 is an owning node for the node identified by SA, the learned association of node address SA to the port p information is stored in an owning table (4B);

In S4, a predetermined function F is calculated depending on the learned node address SA for each node address stored in a registrar table 4D of the network node 1. The registrar table stores addresses of nodes within the network that register addresses, i.e., of registrar nodes.

The calculation function F is in a preferred embodiment known to all network nodes 1 of the network, i.e., the calculation function F is a calculation function F common to all network nodes 1. In one embodiment, the network nodes 1 are configured with a selectable common calculation function.

In S5, from the calculated functions F, the node address is selected whose function F fulfils a predetermined selection criterion. The selection criterion is in a preferred embodiment also a common selection criterion known to all network nodes of the network and configurable.

Finally, in S6, the node address is registered in a registering table 4C of a registrar node identified by the selected network node address.

In one embodiment of the node address registering method according to the present invention, the calculation of the function F in S4 is performed by calculating the absolute difference between the learned node address SA and a node address stored in the registrar table 4D of the learning network node 1.

In one embodiment of the registering method as shown in FIG. 2 in S5, the node address is selected whose calculated function has the minimal absolute value of calculated functions. Accordingly, the predetermined selection criterion is the minimal value.

In an alternative embodiment, another selection criterion is used, such as a maximum value.

The node addresses are in one embodiment MAC addresses as used by an Ethernet network.

The registering process as shown in FIG. 2 is performed in one embodiment each time a network node 1 learns an address of a node within a segment connected to a port of the network node 1 during an operation of the network.

In an alternative embodiment, the registering process as shown in FIG. 2 is performed during a bootstrapping procedure when starting the network operation.

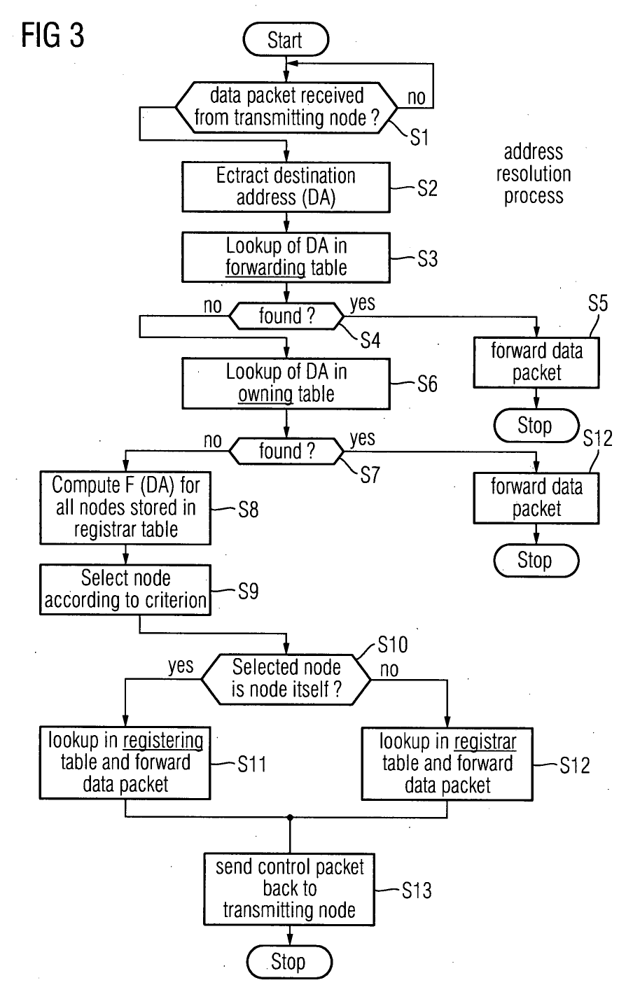

FIG. 3 shows a possible embodiment of an address resolution method for resolving a destination address DA of a data packet DP by a network node 1 according to the present invention.

In the shown embodiment, the network node 1 receives in S1 a data packet DP from another transmitting node.

After reception of a data packet DP having a destination address DA at a port, the network node 1 extracts, e.g. filters, in S2 a destination address DA from the packet header of the received data packet DP.

In S3, the network node 1 performs a first look-up of the destination address DA in its forwarding table 4A which stores for each port of the network node 1 learned node addresses of nodes within a network segment connected to the respective port of the network node 1. If the network node 1 identifies that the destination address DA is present in the forwarding table, it decides in S4 that there is no cache-miss and forwards the received data packet DP to the found port in S5.

Contrary, if the look-up of S3 is unsuccessful, the network node 1 performs a look-up of the destination address in its owning table 4B in S6. If the look-up is successful, the data packet is forwarded to the indicated port. If this look-up is also unsuccessful, the network node 1 calculates in S8 the function F depending on the destination address DA and each node address stored in its registrar table 4D.

Then, in S9, the network node 1 selects from the calculated function F a registrar node address based on a predetermined selection criterion, for instance, a minimum or maximum value.

In S10, the network node 1 confirms whether the selected registrar address is its own address. If so, the network node 1 performs a look-up in its registering table 4C and forwards the data packet DP to the indicated port in S11. Otherwise, the network node 1 performs a look-up in its registrar table 4D and forwards the data packet to the indicated port in S12.

In S11, S12, the received data packet DP is forwarded by the network node 1 to the registrar node identified by the selected registrar node address. In S13, the selected registrar node sends a control packet back to network node 1 containing information about the network node that owns the destination address DA.

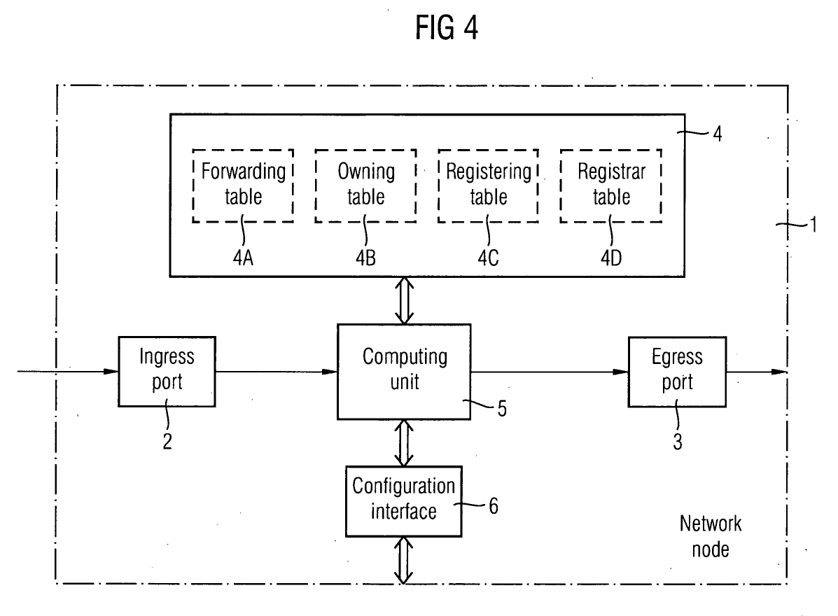

FIG. 4 shows a possible embodiment of a network node 1 for a scalable packet based network according to the present invention. Network node 1 is an advanced bridge device. The network node 1 comprises several ingress ports 2 and several egress ports 3. In a preferred embodiment, the ports 2, 3 are bidirectional and able to receive and transmit data packets, such as Ethernet data packets comprising a header and payload data. Ports 2, 3 are provided for reception and transmission of data packets DP of network segments connected to the respective ports of the network node 1. The network node 1 as shown in FIG. 4 comprises a cache memory 4 having a forwarding table 4A which stores for each port of that network node 1 node addresses of nodes reachable through the respective ports 2, 3.

Network node 1 further comprises in a possible embodiment an owning table 4B that stores the nodes addresses of local nodes attached to ports of the network node 1. A bridge, i.e. network node 1, is a possible registrar node for any other node of the network and can possibly be also the owning network node of such a node if it is directly connected to a port of said network node or to a legacy segment of said network nodes.

The cache memory 4 further comprises a registering table 4C which stores learned node addresses registered in the network node 1 by other network nodes of the same network.

Furthermore, the cache memory 4 of the network node 1 comprises a registrar memory 4D which stores node addresses of registrar nodes of the same network.

The network node 1 as shown in FIG. 4 comprises also computing means 5 having access to the forwarding table 4A, the owning table 4B, the registering table 4C and the registrar table 4D.

The computing means 5 calculates the predetermined function F depending on learned node addresses for each node address stored in the registrar table 4D of the network node 1.

The computing unit 5 selects from the calculated function values a node address whose function value fulfils a predetermined selection criterion, such as a maximum or minimum selection criterion.

The registering process and the address resolution process as shown in FIGS. 2, 3 are performed in a preferred embodiment by the computing means 5 of the network node 1 as shown in FIG. 4. In one embodiment of the network node 1 according to the present invention, the computing means 5 is connected to a function storage storing at least one configurable function F. In one embodiment, the function F calculates the absolute difference between the learned node address and the node addresses stored in the registrar table 4D of the network node 1. The registering process and the look-up process are performed in a preferred embodiment by different calculating units such as processors. In a possible embodiment, the look-up is performed by an ASIC or CAM of said network node 1 whereas the registration is performed by a general purpose processor of said network node 1.

In one embodiment of the network node 1 according to the present invention, the network node 1 further comprises a configuration interface 6 for configuring the network node 1. The network node 1 as shown in FIG. 4 is in a preferred embodiment formed by an Ethernet bridge. The node addresses stored in the forwarding table 4A, the registrar table 4D, the registering table 4C and the owning table 4B are formed in a preferred embodiment by MAC addresses.

In one embodiment of the network node 1 according to the present invention, the network node addresses stored in the registrar table 4D are addresses of network bridges within the network.

FIG. 5 shows a simple example for a scalable packet based network according to the present invention comprising three bridges and four additional nodes directly connected to the bridges, i.e., end-nodes such as host computers.

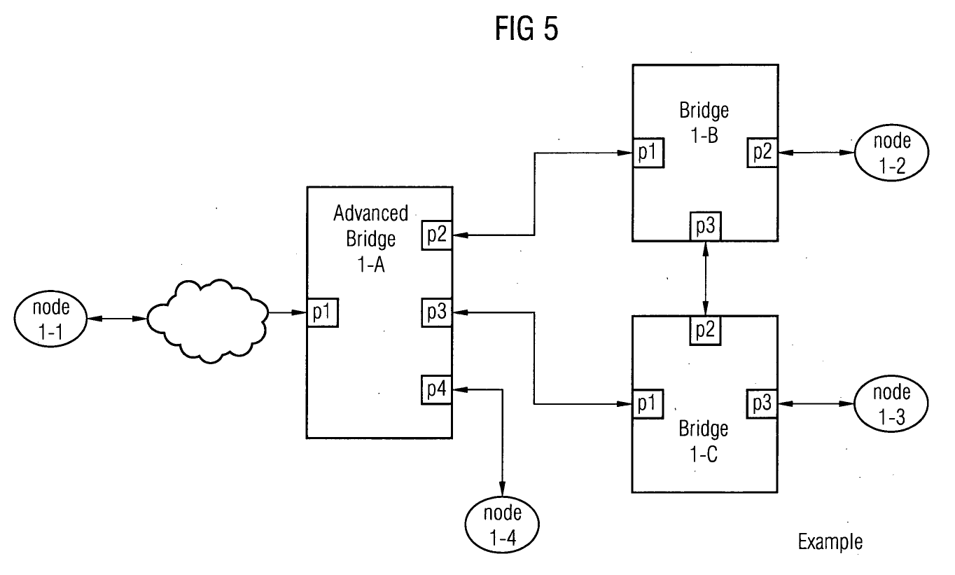

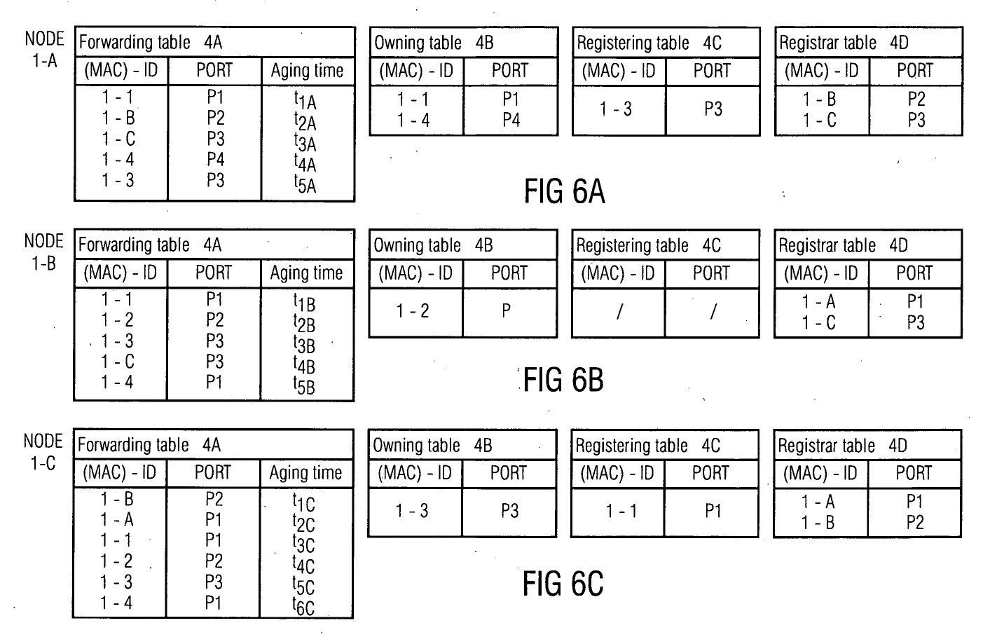

FIGS. 6A-6C show the corresponding tables 4A, 4B, 4C, 4D stored within network nodes 1A, 1B, 1C as shown in FIG. 5.

When a node 1-1 sends a data packet DP to a destination address DA 2# identifying node 1-2, such data packet DP arrives at port P1 of bridge 1A. In the given example, node 1-1 is not directly connected to port P1 of a network node 1-A, i.e. bridge 1-A, but indirectly, for instance, via conventional state-of-the-art bridges (legacy segment). Bridge 1A performs a look-up for DA in its forwarding table 4A and does not find a destination address DA 2# of node 1-2 as shown in FIG. 6A, thus a cache-miss occurs.

If the look-up of address DA in the owning table 4B of network node 1-A is also unsuccessful, the network node 1-A, i.e. bridge 1A, calculates a function value depending on a calculation function F and depending on the destination address DA of the received data packet DP as well as on the node addresses stored in the registrar table 4D, i.e., in the given example for network node addresses B# and C# of bridges 1-B, 1-C. For instance, bridge 1-A calculates the absolute difference between the destination address DA of the received data packet DP and the respective network node addresses stored in its registrar table 4D. In the given example, the bridge 1A relies on function F to calculate the sub-values F_{B}=|2#−B#| and F_{C}=|2#−C#| as indicated by S8 of FIG. 3.

Then, the computing means 5 of the bridge 1-A select from the calculated function values F the registrar node address whose function value fulfils a predetermined selection criterion which forms, e.g. the minimum value. The minimum value {F_{B}, F_{C}} might be in the given example F_{C}.

Accordingly, the bridge 1-A sends the data packet DP which it has received at its port P1 according to the respective entry of its forwarding table 4A via its port P3 to bridge 1-C as shown in FIG. 5.

Bridge 1-C receives the data packet DP at its port P1 and performs a look-up in its own forwarding table 4A. In the shown example, such entry is in the forwarding table and thus bridge 1-C forwards the data packet DP via its port P2 to the port P3 of bridge 1-B. However, if that was not the case (due e.g. to ageing) then bridge 1-C computes function F for the address DA and realizes that it is the registrar node for this address. Therefore, bridge 1-C then performs a second lookup for an entry for address DA in its registering table 4C. The ageing time stored in the forwarding table 4A indicates a time period after which the respective entry is deleted when no data packet has been forwarded to the stored address within said time period.

Bridge 1-C also sends a control packet back to notify bridge 1-A that the owner of address DA is in fact bridge 1-B.

Bridge 1-B receives the data packet DP at its port P3, filters the destination address DA of the received data packet DP from the packet header as indicated in S2 of FIG. 3 and performs a look-up for the extracted destination address DA in its forwarding table 4A. In the given example as shown in FIG. 6B, the address 2# can be found in the forwarding table 4A of bridge 1-B and the bridge 1B forwards the data packet DP as indicated in S5 of FIG. 3 to the node 1-2.

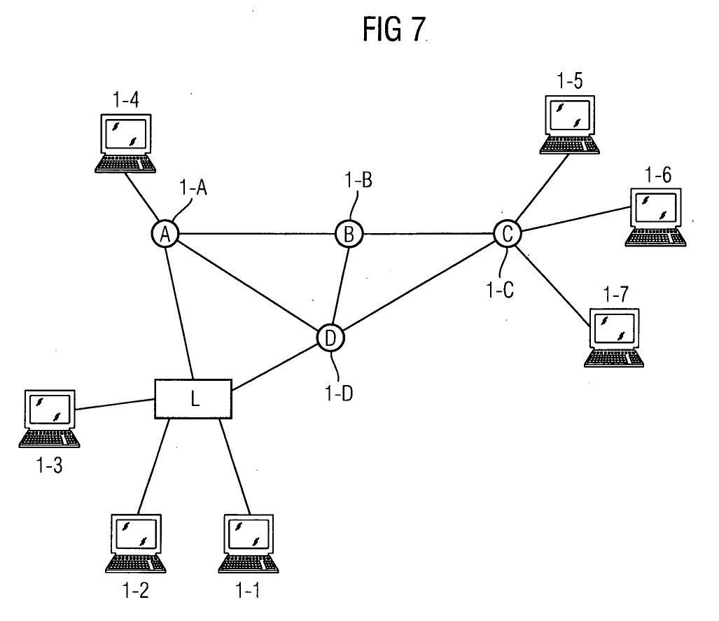

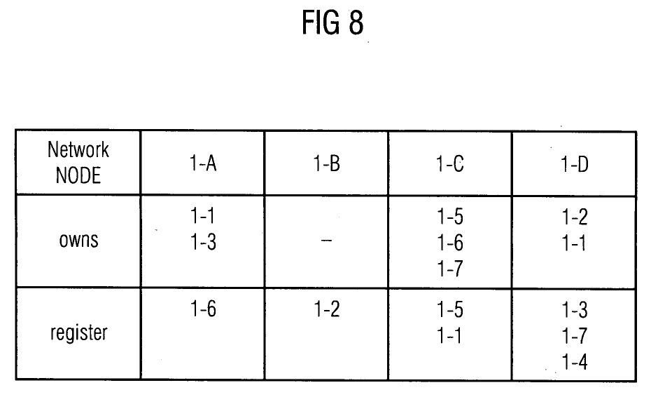

FIG. 7 shows a further exemplary scalable packet based network according to the present invention. In this exemplary network, there are four network nodes or bridges 1-A, 1-B, 1-C, 1-D and nodes 1-1 to 1-7. The network nodes 1-A, 1-B, 1-C, 1-D, implement the mechanism according to the present invention, i.e., the registering mechanism as shown in FIG. 2 and the address resolution mechanism as shown in FIG. 3 are implemented. Accordingly, the network nodes 1-A, 1-B, 1-C, 1-D in FIG. 7 are formed, for example, by a network node 1 as shown in FIG. 4 having computing means 5, a forwarding table 4A, an owning table 4B, a registering table 4C and a registrar table 4D. The network as shown in FIG. 7 further comprises a legacy network segment consisting of at least one legacy bridge L to which three end-nodes 1-1, 1-2, 1-3 are connected. The legacy bridge L is a conventional bridge which does not implement the mechanism according to the present invention. A network node 1 owns another node when this node is directly connected to the network node 1 or the node is connected to a legacy network segment and the network node or bridge is responsible for this node. In the given example of FIG. 7, network node 1-A owns node 1-4 because it is directly connected to the end-node 1-4, and owns node 1-3-node is connected to the legacy network segment L, which the network node 1-A is responsible for. Furthermore, the network node or bridge 1-C, which is the owner of network end-node 1-6, has chosen network 1-A to store the node address of end-node 1-6, i.e., node 1-A is a registrar node for the address of node 1-6. Therefore, the address of node 1-6 is stored in the registering table 4C of bridge 1-A. In the same manner, bridge 1-D which is the owner of node 1-2 connected to the legacy network segment L has chosen network node 1-B to be the registrar node for node 1-2. Therefore, bridge 1-D registers the address of node 1-2 with bridge 1-B after having performed the calculating and selecting S4, S5 as shown in FIG. 2. Bridge 1-B then stores the address of node 1-2 in its registering table 4C.

The deterministic function F has an input value of an address of a node x, i.e. the result of F(x) uniquely identifies the registrar node for the address of x. The deterministic function F is known to all network nodes 1 within the network. Each network node 1 can therefore use the deterministic function F to determine the identity of the registrar node for any unknown (not in the forwarding table) address. Accordingly, when network node 1 receives a data packet DP whose destination address y is unknown (not in the forwarding table), the network node 1 computes F(y) to identify the registrar node R(y) for address y. It then sends packet DP addressed to destination address y to R(y). This way, the method according to the present invention avoids the state-of-the art broadcasting which wastes network resources.

The deterministic function F(x) is a function that computes the minimum between the address x and the identification address of the registrar node or bridge. In case that the computed minimum value is not unique, i.e., F(x) results in the same minimum value for more than one registered bridge node then one of the minimal values is chosen in a deterministic fashion. To give a specific example, assuming that the identifiers (in this case the address) are drawn from a linearly total ordered set number, such as R, e.g. the set of real numbers, then there are at least two minimal values and the network node bridge having a smaller ID is chosen. Thus, for a given address, the registrar node can be unambiguously identified.

A scalable packet-based network according to the present invention has the advantage that it avoids broadcasts in the event of a cache-miss in a forwarding table 4A of a network node. Accordingly, the present invention increases the scalability of an Ethernet implemented network.

With the mechanism according to the present invention, the storage requirement per network node 1 is only slightly increased, i.e. the network node acting as a registrar for a specific node address needs to store the location of the addresses for which it is the registrar node in addition to the addresses it owns itself.

The method according to the present invention decouples a forwarding mechanism from a learning mechanism for learning the location of an address. In a conventional Ethernet network, the forwarding process and the learning process are coupled which forces the existence of only one path between any pair of nodes, i.e. the Ethernet spanning tree that is used for packet forwarding. This is because, in the conventional Ethernet, allocations of addresses are learned based on a reply to an initial broadcast so that a node subsequently forwards data packets destined to said address on the link for which the reply was received by said node. With the method according to the present invention, such a constraint is lifted and, hence, a more flexible data packet forwarding is achieved.

A further advantage of the method according to the present invention is that it can be deployed in an incremental manner, i.e., the method and network node according to the present invention is backward compatible with current legacy Ethernet bridges.

Even when the invention was mostly described with reference to an Ethernet network, it has to be understood that the invention is applicable for any packet-based network consisting of network nodes, in particular, to any network employing a flat addressing scheme.

1. A method for registering a node address learned by a network node in a registrar node comprising:
(a) filtering a source address of a data packet received at a port of an owning network node to learn an address of a node within a network segment connected to said port;
(b) storing the learned node address in a forwarding table of said network node in relation to said port;
(c) storing the learned node address in an owning table of said network node;
(d) computing a predetermined function which depends on the learned node address for each node address stored in a registrar table of said owning network node to supply the owning network node with a registrar node address according to a predetermined criterion,
(e) wherein the owning network node registers the learned node address with a registering table of the registrar node indicated by said registrar node address.

2. The method according to claim 1, wherein each network node also stores in a registrar table node addresses of all nodes capable of accepting registration of node addresses.

3. The method according to claim 2,
wherein the function includes calculating an absolute difference between the learned node address and the node addresses stored in the registrar table of said network node.

4. The method according to claim 3,
wherein the node address that is selected yields the minimum said absolute difference.

5. The method according to claim 1,
wherein the node and network node addresses are formed by MAC addresses.

6. The method according to claim 1,
wherein the network nodes are formed by Ethernet bridges of an Ethernet network.

7. The method according to claim 1,
wherein the method is performed each time a network node learns an address of a node within a segment connected to said port of said network node during an operation of the network.

8. The method according to claim 1, wherein the method is performed periodically right from a bootstrapping procedure for starting the network operation whenever the owning table of a network node is nonempty

9. An address resolution method for a destination address of a data packet, comprising:
(a) receiving the data packet having the destination address at a port of a network node;
(b) performing a look-up for the destination address in a forwarding table of said network node which stores for each port of said network node, node addresses of nodes reachable through the respective port of said network node,
(c) wherein if the destination address is not present in said forwarding table, a predetermined function is computed to supply a registrar node address according to a predetermined criterion to the network node;
(d) forwarding the data packet by the network node to the network node identified by the registrar network node address.

10. The method according to claim 9,
wherein a control packet is sent by the selected registrar node to the network node containing information about the network node that owns the destination address.

11. The method according to claim 9,
wherein the function is computed by calculating an absolute difference between the learned node address and the network node addresses stored in said registrar table of said network node.

12. The method according to claim 9,
wherein the network node address is selected whose calculated function value has the minimal value of all calculated function values.

13. The method according to claim 9,
wherein the node and network node addresses are formed by MAC addresses.

14. The method according to claim 9,
wherein the network node addresses are formed by network node addresses of network bridges.

15. A network node for a scalable packet based network comprising:
(a) ports for reception and transmission of data packets;
(b) a forwarding table which stores associations between learned addresses of received data packets and the ports of the said network node by means of which the nodes identified by such addresses can be reached;
(c) an owning table which stores addresses of local nodes wherein local nodes are nodes connected to the owning node by means of a network segment;
(d) a registering table which stores node addresses registered with the network node wherein the network node forms a registrar node for these addresses; and
(e) a registrar table which stores information data on all network nodes which are registrar nodes of said network.

16. The network node according to claim 15,
wherein the network node further comprises computing means for learning network node addresses of network nodes connected to a port and for storing the learned network node addresses in said forwarding table in relation with a respective port.

17. The network node according to claim 16,
wherein said computing means calculates a predetermined calculation function depending on the learned node addresses for each network node address stored in the registrar table of said network node.

18. The network node according to claim 17,
wherein the computing means selects from the calculated functions a network node address whose function fulfils a predetermined selection criterion.

19. The network node according to claim 18,
wherein the learned node address is registered by said network node in a registering table of a registrar node identified by the selected network node address.

20. The network node according to claim 15,
wherein the network node performs a look-up for a destination address of a received data packet in the forwarding table.

21. The network node according to claim 17,
wherein the calculation function is formed by a subtracting function which calculates an absolute difference between the learned node address and the network node addresses stored in said registrar table of said network node.

22. The network node according to claim 18,
wherein the selection criterion is to select a minimal function value of all calculated function values.

23. The network node according to claim 18,
wherein the selection criterion is to select a maximum function value of all calculated function values.
